(19) United States
(12) Patent Application Publication
(10) Pub. No.: US 2026/0115702 A1
(43) Pub. Date: Apr. 30, 2026

(54) METHOD FOR PREPARING MCM-41-TYPE CATALYST

(71) Applicant: SHINY CHEMICAL INDUSTRIAL CO., LTD., Kaohsiung City (TW)

(72) Inventors: Che-Lun Yeh, Kaohsiung City (TW); Chao-Hsun Su, Kaohsiung City (TW); Chi-Fa Sun, Kaohsiung City (TW)

(73) Assignee: SHINY CHEMICAL INDUSTRIAL CO., LTD., Kaohsiung City (TW)

(21) Appl. No.: 19/004,836

(22) Filed: Dec. 30, 2024

(30) Foreign Application Priority Data
Oct. 30, 2024 (TW) 113141670

(51) Int. Cl. B01J 29/03; B01J 37/02; B01J 37/04; B01J 37/06; B01J 37/08

(52) U.S. Cl. CPC B01J 29/0308; B01J 37/0236; B01J 37/04; B01J 37/06; B01J 37/082

(57) ABSTRACT

A method for preparing an MCM-41-type catalyst includes: mixing tetraethoxysilane, cetyltrimethylammonium bromide, a metal compound, sulfonated tripropylene glycol methyl ether, sodium hydroxide and water to obtain a mixture solution, the metal compound ranging from 0.03 mole to 0.10 mole based on 1.0 mole of the tetraethoxysilane, the sulfonated tripropylene glycol methyl ether ranging from 0.1 mole to 0.3 mole based on 1.0 mole of the cetyltrimethylammonium bromide; adjusting pH value of the mixture solution to obtain a colloidal solution; subjecting the colloidal solution to a heating treatment, so as to form a catalyst precursor; subjecting the catalyst precursor to a washing process, so as to obtain a washed catalyst precursor; subjecting the washed catalyst precursor to a drying treatment so as to obtain a dried catalyst precursor; and subjecting the dried catalyst precursor to a calcination treatment.

### CROSS-REFERENCE TO RELATED APPLICATION

This application claims priority to Taiwanese Invention Patent Application No. 113141670, filed on Oct. 30, 2024, the entire disclosure of which is incorporated by reference herein.

### FIELD

The present disclosure relates to a method for preparing a catalyst, and more particularly to a method for preparing an MCM-41-type catalyst.

### BACKGROUND

MCM-41 catalysts have a pure silicate framework formed from tetraethoxysilane, which is formed by utilizing micelles made from a surfactant, e.g. cetyltrimethylammonium bromide that serves as a template.

At present, when MCM-41 catalysts prepared by conventional methods are used to produce secondary alcohols, e.g., propylene glycol monomethyl ether, problems such as the secondary alcohols cannot be completely obtained and some primary alcohol by-products are produced, exist. Therefore, those skilled in the art endeavor to develop new methods for preparing MCM-41-type catalysts, such that when such MCM-41-type catalysts are used to produce secondary alcohols, e.g., propylene glycol monomethyl ether, the yield of the secondary alcohols thus produced can be increased as much as possible.

### SUMMARY

Therefore, an object of the present disclosure is to provide a method for preparing an MCM-41-type catalyst that can alleviate at least one of the drawbacks of the prior art.

According to the present disclosure, the method includes the steps of:
(a) mixing tetraethoxysilane, cetyltrimethylammonium bromide, a metal compound, sulfonated tripropylene glycol methyl ether, sodium hydroxide and water, such that the cetyltrimethylammonium bromide and the sulfonated tripropylene glycol methyl ether form a micelle template, thereby obtaining a mixture solution containing the micelle template, the metal compound being present in an amount ranging from 0.03 mole to 0.10 mole based on 1.0 mole of the tetraethoxysilane, the sulfonated tripropylene glycol methyl ether being present in an amount ranging from 0.1 mole to 0.3 mole based on 1.0 mole of the cetyltrimethylammonium bromide;
(b) adjusting a pH value of the mixture solution to range from 9.5 to 10.5, such that the metal compound of step (a) in the mixture solution is converted to a metal hydroxide compound which precipitates from the mixture solution, thereby obtaining a colloidal solution containing the metal hydroxide compound, the tetraethoxysilane of step (a), and the micelle template of step (a);
(c) subjecting the colloidal solution to a heating treatment, such that the tetraethoxysilane of step (a) is hydrolyzed to form an ethoxy group-containing silicon hydroxide, and such that the ethoxy group-containing silicon hydroxide and the metal hydroxide compound of step (b) self-assemble to cover the micelle template of step (a), thereby forming a catalyst precursor;
(d) subjecting the catalyst precursor to a washing process until a pH value of a washing liquid generated by the washing process ranges from 7.0 to 7.5, so as to obtain a washed catalyst precursor;
(e) subjecting the washed catalyst precursor to a drying treatment so as to obtain a dried catalyst precursor; and
(f) subjecting the dried catalyst precursor to a calcination treatment conducted at a temperature ranging from 300° C. to 500° C., so as to remove an organic substance containing the micelle template of step (a) from the dried catalyst precursor, thereby obtaining the MCM-41-type catalyst.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

A method for according to the present disclosure includes the following steps (a) to (f).

In step (a), tetraethoxysilane, cetyltrimethylammonium bromide, a metal compound, sulfonated tripropylene glycol methyl ether, sodium hydroxide and water were mixed, such that the cetyltrimethylammonium bromide and the sulfonated tripropylene glycol methyl ether form a micelle template, thereby obtaining a mixture solution containing the micelle template. The metal compound is present in an amount ranging from 0.03 mole to 0.10 mole based on 1.0 mole of the tetraethoxysilane. The sulfonated tripropylene glycol methyl ether is present in an amount ranging from 0.1 mole to 0.3 mole based on 1.0 mole of the cetyltrimethylammonium bromide.

In step (b), the pH value of the mixture solution is adjusted to range from 9.5 to 10.5, such that the metal compound of step (a) in the mixture solution is converted to a metal hydroxide compound which precipitates from the mixture solution, thereby obtaining a colloidal solution containing the metal hydroxide compound, the tetraethoxysilane of step (a), and the micelle template of step (a).

In step (c), the colloidal solution is subjected to a heating treatment, such that the tetraethoxysilane of step (a) is hydrolyzed to form an ethoxy group-containing silicon hydroxide, and such that the ethoxy group-containing silicon hydroxide and the metal hydroxide compound of step (b) self-assemble to cover the micelle template of step (a), thereby forming a catalyst precursor.

In step (d), the catalyst precursor is subjected to a washing process until a pH value of a washing liquid generated by the washing process ranges from 7.0 to 7.5, so as to obtain a washed catalyst precursor.

In step (e), the washed catalyst precursor is subjected to a drying treatment so as to obtain a dried catalyst precursor.

In step (f), the dried catalyst precursor is subjected to a calcination treatment conducted at a temperature ranging from 300° C. to 500° C., so as to remove an organic substance containing the micelle template of step (a) from the dried catalyst precursor, thereby obtaining the MCM-41-type catalyst.

In step (a), the cetyltrimethylammonium bromide and the sulfonated tripropylene glycol methyl ether serve as surfactants and form the micelle template, such that the tetraethoxysilane is allowed to self-assemble in subsequent step according to the shape of the micelle template. The micelle template may have a columnar shape, but is not limited thereto.

According to the present disclosure, the sulfonated tripropylene glycol methyl ether is a compound represented by formula (I),

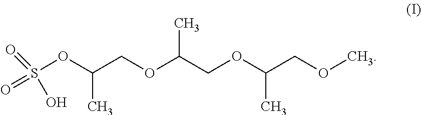 [SMILES: COCC(C)OCC(C)OCC(C)OS(=O)(=O)O]

By addition of the sulfonated tripropylene glycol methyl ether, the pore size and the specific surface area of the thus obtained MCM-41-type catalyst can be adjusted, such that when such MCM-41-type-catalyst is used to produce secondary alcohols, selectivity of the secondary alcohols can be improved and formation of primary alcohol by-products can be reduced.

In certain embodiments, the sulfonated tripropylene glycol methyl ether is obtained by subjecting tripropylene glycol methyl ether and chlorosulfuric acid to a reaction, in which the tripropylene glycol methyl ether is present in an amount ranging from 1.0 mole to 1.2 mole based on 1.0 mole of the chlorosulfuric acid. In an exemplary embodiment, the tripropylene glycol methyl ether and the chlorosulfuric acid are mixed under reduced pressure and then reacted at 100° C. for 24 hours, so as to obtain a crude product, followed by heating the crude product so that the tripropylene glycol methyl ether remaining in the crude product is distilled out, thereby obtaining the sulfonated tripropylene glycol methyl ether with a yield of greater than 98%.

According to the present disclosure, the metal compound can be used to alter the microstructure of MCM-41-type catalyst having a pure silicate framework, such that after self-assembly of the ethoxy group-containing silicon hydroxide formed by hydrolysis of the tetraethoxysilane, the MCM-41-type catalyst having a composite framework that is different from the pure silicate framework is obtained, thereby enhancing structural configuration of the MCM-41-type catalyst and reducing formation of primary alcohol by-products when such MCM-41-type catalyst is used to produce secondary alcohols. In addition, the pH value of the MCM-41-type catalyst can be adjusted depending on the types of the metal compound used, thereby allowing preparation of a catalyst that meets reaction requirements and that facilitates progression of a catalytic reaction. The types of the metal compound are not particularly limited, and any type of metal compound may be applied as long as the aforesaid effects can be achieved. Examples of the metal compound may include, an organic titanium compound, an inorganic titanium compound, an organic magnesium compound, an inorganic magnesium compound, an organic aluminum compound, an inorganic aluminum compound, or combinations thereof. In certain embodiments, the metal compound is the organic titanium compound. An example of the organic titanium compound may include, titanium isopropoxide. In certain embodiments, the metal compound is the organic aluminum compound. An example of the organic aluminum compound may include, aluminum isopropoxide.

According to the present disclosure, by controlling the amount of the metal compound to range from 0.03 mole to 0.10 mole based on 1.0 mole of the tetraethoxysilane, when the MCM-41-type catalyst is used to produce secondary alcohols, the selectivity of the secondary alcohols thus obtained can be improved. In addition, by controlling the amount of the sulfonated tripropylene glycol methyl ether to range from 0.1 mole to 0.3 mole based on 1.0 mole of the cetyltrimethylammonium bromide, the pores of the MCM-41-type catalyst can be controlled to have an appropriate size, thereby being conducive to obtaining secondary alcohols.

In certain embodiments, the cetyltrimethylammonium bromide is present in an amount ranging from 0.9 mole to 1.3 mole, the sodium hydroxide is present in an amount ranging from 0.24 mole to 0.30 mole, and the water is present in an amount ranging from 100 mole to 120 mole based on 1.0 mole of the tetraethoxysilane. To be specific, by controlling the amount of the cetyltrimethylammonium bromide to be greater than 0.9 mole, the pores in the micelle template can be formed to have a uniform size; and by controlling the amount of the cetyltrimethylammonium bromide to be not greater than 1.3 mole, formation of pores with uneven size in the micelle template can be avoided, thereby facilitating removal of the micelle template in subsequent step.

In step (b), the pH value of the mixture solution is adjusted such that the metal compound of step (a) in the mixture solution can be converted to the metal hydroxide compound which precipitates from the mixture solution, and thus a portion of silicon elements in the pure silicate framework, which is formed by ethoxy group-containing silicon hydroxide from hydrolysis of the tetraethoxysilane, can be replaced with metal elements of the metal hydroxide compound, thereby achieving the purpose of altering the microstructure of the MCM-41-type catalyst obtained in subsequent step, i.e., the MCM-41-type catalyst having the pure silicate framework is altered to the MCM-41-type catalyst having the composite framework. The procedures for adjusting the pH value of the mixture solution are not particularly limited, and any procedures may be applied as long as the pH value of the mixture solution can be adjusted to range from 9.5 to 10.5. For example, the pH value of the mixture solution may be adjusted using an acidic reagent, but is not limited thereto. In certain embodiments, in step (b), the pH value of the mixture solution is adjusted using a concentrated hydrochloric acid.

In step (c), a temperature of the heating treatment is not particularly limited, and the heating treatment may be conducted at any temperature as long as the tetraethoxysilane can be hydrolyzed to form the ethoxy group-containing silicon hydroxide, such that the ethoxy group-containing silicon hydroxide and the metal hydroxide compound formed in step (b) can self-assemble to cover the micelle template formed in step (a). In certain embodiments, the temperature of the heating treatment ranges from 80° C. to 100° C.

In step (d), the catalyst precursor is subjected to the washing process to remove residues of salt from the catalyst precursor, thereby preventing salt from absorbing water and affecting surface catalytic activity of the MCM-41-type catalyst obtained in subsequent step.

In step (f) of certain embodiments, the organic substance, apart from containing the micelle template formed in step (a), further contains another element derived from an organic metal compound when the type of the metal compound is the organic metal compound.

The present disclosure will be described by way of the following examples. However, it should be understood that the following examples are intended solely for the purpose of illustration and should not be construed as limiting the present disclosure in practice.

### Preparation Examples: Preparation of Sulfonated Tripropylene Glycol Methyl Ether

### Preparation Example 1 (PE1)

First, tripropylene glycol methyl ether and chlorosulfuric acid were mixed, i.e., the tripropylene glycol methyl ether was present in an amount ranging from 1.0 mole to 1.2 mole based on 1.0 mole of the chlorosulfuric acid, under a reduced pressure, and then reacted at 100° C. for 24 hours so as to obtain a crude product, followed by heating the crude product so that the tripropylene glycol methyl ether remaining in the crude product was distilled out, thereby obtaining a sulfonated tripropylene glycol methyl ether of PE1 with a yield of greater than 98%.

### Examples: Preparation of MCM-41-Type Catalyst

### Example 1 (E1)

First, 1.0 mole of tetraethoxysilane (abbreviated as TEOS), 1.1 mole of cetyltrimethylammonium bromide (abbreviated as CTAB), 0.11 mole of sulfonated tripropylene glycol methyl ether of PE1 (abbreviated as sulfonated TPM, and present in an amount of 0.1 mole based on 1.0 mole of the CTAB), 0.1 mole of aluminum isopropoxide, 0.27 mole of sodium hydroxide, and 110 mole of water were mixed under stirring for 24 hours, such that the CTAB and the sulfonated TPM formed a micelle template, thereby obtaining a mixture solution containing the micelle template.

Next, a pH value of the mixture solution was adjusted to range from 9.5 to 10.5, such that the aluminum isopropoxide in the mixture solution was converted to solid aluminum hydroxide which precipitated from the mixture solution, thereby obtaining a colloidal solution containing the tetraethoxysilane, the micelle template, and the aluminum hydroxide.

Afterwards, the colloidal solution was subjected to a heating treatment using a reflux device at a temperature ranging from 80° C. to 100° C. for 24 hours, such that the tetraethoxysilane was hydrolyzed to form an ethoxy group-containing silicon hydroxide, and such that the ethoxy group-containing silicon hydroxide and the aluminum hydroxide in the colloidal solution self-assembled to cover the micelle template, so as to form a composite framework, thereby obtaining a catalyst precursor including the micelle template and the composite framework.

Thereafter, the catalyst precursor was subjected to a washing process by placing into water, followed by conducting a centrifugation treatment to separate the catalyst precursor from a washing liquid generated by the washing process, and the aforesaid washing process and the centrifugation treatment were repeated several times until a pH value of the washing liquid generated by the washing process ranged from 7.0 to 7.5, thereby obtaining a washed catalyst precursor.

Subsequently, the washed catalyst precursor was subjected to a drying treatment conducted at 100° C. so as to remove moisture therefrom, thereby obtaining a dried catalyst precursor.

Finally, the dried catalyst precursor was subjected to a calcination treatment conducted at 500° C., so as to remove an organic substance containing the micelle template from the dried catalyst precursor, thereby obtaining a MCM-41-type catalyst of E1.

### Examples 2 to 6 and Comparative Examples 1 to 5 (E2 to E6 and CE1 to CE5)

The procedures for preparing the MCM-41-type catalyst of E2 to E6 and CE1 to CE5 were substantially similar to those of E1, except for differences in the type and/or amount of each component in the mixture solution, and the temperature of the calcination treatment, as shown in Tables 1 to 3 below. It should be noted that, the metal compound was not added in CE1, the sulfonated TPM was not added in CE3 and CE4, and both the metal compound and the sulfonated TPM were not added in CE5.

### Property Evaluation

### 1. Pore Size and Specific Surface Area

A respective one of the MCM-41-type catalyst of E1 to E6 and CE1 to CE5 was subjected to determination of pore size and specific surface area using a high-performance adsorption analyzer (Manufacturer: Micromeritics Instrument Corporation; Model number: 3Flex 3500) with gas adsorption method. The results are shown Tables 1 to 3.

### 2. Yield of Secondary Alcohol

First, a respective one of the MCM-41-type catalyst of E1 to E6 and CE1 to CE5 was mixed with propylene oxide and methanol, and then subjected to a reaction at 120° C., so as to obtain a test sample containing propylene glycol monomethyl ether (i.e., a secondary alcohol). Next, the test sample was subjected to analysis using a gas chromatograph (Manufacturer: Agilent Technologies, Inc.; Model number: 7890A), so as to determine the yield of propylene glycol monomethyl ether in the test sample. The results are shown in Tables 1 to 3. The yield of propylene glycol monomethyl ether was then used to evaluate the efficacy of the MCM-41-type catalyst in the production of secondary alcohols.

TABLE 1

| | | E1 | E2 | E3 |
|---|---|---|---|---|
| TEOS (mole) | | 1.0 | 1.0 | 1.0 |
| CTAB (mole) | | 1.1 | 1.1 | 1.1 |
| Metal | Type | Aluminum | Aluminum | Aluminum |
| compound | | isopropoxide | isopropoxide | isopropoxide |
| | Amount (mole) | 0.05 | 0.05 | 0.05 |
| Sulfonated TPM (mole) | | 0.11 | 0.22 | 0.22 |
| Sodium hydroxide (mole) | | 0.27 | 0.27 | 0.27 |
| Water (mole) | | 110 | 110 | 110 |
| Drying treatment (° C.) | | 100 | 100 | 100 |
| Calcination treatment (° C.) | | 500 | 500 | 300 |
| MCM-41-type | Pore size (nm) | 2.8 | 2.7 | 2.7 |
| catalyst | Specific surface | 971.2 | 1014.2 | 998.2 |
| | area (m²/g) | | | |

| | | | |
|---|---|---|---|
| Yield of secondary alcohols (%) | 91.8 | 92.1 | 91.7 |

TABLE 2

| | | E4 | E5 | E6 |
|---|---|---|---|---|
| TEOS (mole) | | 1.0 | 1.0 | 1.0 |
| CTAB (mole) | | 1.1 | 1.1 | 1.1 |
| Metal | Type | Titanium | Titanium | Titanium |
| compound | | isopropoxide | isopropoxide | isopropoxide |
| | Amount (mole) | 0.05 | 0.05 | 0.05 |
| Sulfonated TPM (mole) | | 0.22 | 0.11 | 0.11 |
| Sodium hydroxide (mole) | | 0.27 | 0.27 | 0.27 |
| Water (mole) | | 110 | 110 | 110 |
| Drying treatment (° C.) | | 100 | 100 | 100 |
| Calcination treatment (° C.) | | 500 | 500 | 300 |
| MCM-41-type | Pore size (nm) | 2.7 | 2.8 | 2.8 |
| catalyst | Specific surface | 989.3 | 965.4 | 958.7 |
| | area (m²/g) | | | |

| | | | |
|---|---|---|---|
| Yield of secondary alcohols (%) | 91.9 | 91.2 | 91.0 |

TABLE 3

| | | CE1 | CE2 | CE3 | CE4 | CE5 |
|---|---|---|---|---|---|---|
| TEOS (mole) | | 1.0 | 1.0 | 1.0 | 1.0 | 1.0 |
| CTAB (mole) | | 1.1 | 1.1 | 1.1 | 1.1 | 1.1 |
| Metal | Type | — | Aluminum | Aluminum | Titanium | — |
| compound | | | isopropoxide | isopropoxide | isopropoxide | |
| | Amount (mole) | 0 | 0.05 | 0.02 | 0.15 | 0 |
| Sulfonated TPM (mole) | | 0.07 | 0.45 | 0 | 0 | 0 |
| Sodium hydroxide (mole) | | 0.27 | 0.27 | 0.27 | 0.27 | 0.27 |
| Water (mole) | | 110 | 110 | 110 | 110 | 110 |
| Drying treatment (° C.) | | 100 | 100 | 100 | 100 | 100 |
| Calcination treatment (° C.) | | 300 | 300 | 300 | 300 | 500 |
| MCM-41- | Pore size (nm) | 2.9 | 2.7 | 2.9 | 2.9 | 2.9 |
| type | Specific | 932.8 | 1012.3 | 922.3 | 928.7 | 932.8 |
| catalyst | surface area | | | | | |
| | (m²/g) | | | | | |

| | | | | | |
|---|---|---|---|---|---|
| Yield of secondary alcohols | 90.5 | 90.9 | 90.1 | 90.2 | 90.8 |

“—”: not added

Referring to Tables 1 and 2, in the preparation of the MCM-41-type catalysts of E1 to E6, by virtue of adding the metal compound and the sulfonated tripropylene glycol methyl ether, by controlling the amount of the metal compound to range from 0.03 mole to 0.10 mole based on 1.0 mole of the tetraethoxysilane, and by controlling the amount of the sulfonated tripropylene glycol methyl ether to range from 0.1 mole to 0.3 mole based on 1.0 mole of the cetyltrimethylammonium bromide, the thus obtained MCM-41-type catalysts of E1 to E6, when used to produce secondary alcohols, each exhibited a yield of secondary alcohols of greater than 91.0%.

The discussions regarding the MCM-41-type catalysts of CE1 to CE5, as shown by the results in Table 3, were as follows: in the preparation of the MCM-41-type catalyst of CE1, the metal compound was not added, and the amount of the sulfonated tripropylene glycol methyl ether was not controlled to range from 0.1 mole to 0.3 mole based on 1.0 mole of the cetyltrimethylammonium bromide, and thus, the MCM-41-type catalyst of CE1, when used to produce secondary alcohols, only exhibited a yield of 90.5%, which was less than 91.0%; in the preparation of the MCM-41-type catalyst of CE2, although the metal compound and the sulfonated tripropylene glycol methyl ether were added, however, the amount of the sulfonated tripropylene glycol methyl ether was not controlled to range from 0.1 mole to 0.3 mole based on 1.0 mole of the cetyltrimethylammonium bromide, and thus the MCM-41-type catalyst of CE2, when used to produce secondary alcohols, only exhibited a yield of 90.9%, which was less than 91.0%; in the preparation of each of the MCM-41-type catalysts of CE3 and CE4, the sulfonated tripropylene glycol methyl ether was not added, and the amount of the metal compound was not controlled to range from 0.03 mole to 0.1 mole based in 1.0 mole of the tetraethoxysilane, and thus the MCM-41-type catalysts of CE3 and CE4, when used to produce secondary alcohols, only exhibited yields of 90.1% and 90.2%, respectively, which were less than 91.0%; and in the preparation of the MCM-41-type catalyst of CE5, which was equivalent to the preparation of conventional MCM-41-type catalyst, the metal compound and the sulfonated tripropylene glycol methyl ether were not added, and thus the MCM-41-type catalyst of CE5, when used to produce secondary alcohols, only exhibited a yield of 90.8%, which was less than 91.0%.

In summary, in the method for preparing the MCM-41-type catalyst of the present disclosure, by virtue of adding the metal compound and the sulfonated tripropylene glycol methyl ether, controlling the relative amounts between the metal compound and the tetraethoxysilane, and controlling the relative amounts between the sulfonated tripropylene glycol methyl and the cetyltrimethylammonium bromide, the MCM-41-type catalyst obtained by the method of the present disclosure, when used to produce secondary alcohols, e.g., propylene glycol monomethyl ether, is capable of increasing the yield of the secondary alcohols. Therefore, the purpose of the present disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for preparing an MCM-41-type catalyst, comprising the steps of:
(a) mixing tetraethoxysilane, cetyltrimethylammonium bromide, a metal compound, sulfonated tripropylene glycol methyl ether, sodium hydroxide and water, such that the cetyltrimethylammonium bromide and the sulfonated tripropylene glycol methyl ether form a micelle template, thereby obtaining a mixture solution containing the micelle template, the metal compound being present in an amount ranging from 0.03 mole to 0.10 mole based on 1.0 mole of the tetraethoxysilane, the sulfonated tripropylene glycol methyl ether being present in an amount ranging from 0.1 mole to 0.3 mole based on 1.0 mole of the cetyltrimethylammonium bromide;
(b) adjusting a pH value of the mixture solution to range from 9.5 to 10.5, such that the metal compound of step (a) in the mixture solution is converted to a metal hydroxide compound which precipitates from the mixture solution, thereby obtaining a colloidal solution containing the metal hydroxide compound, the tetraethoxysilane of step (a), and the micelle template of step (a);
(c) subjecting the colloidal solution to a heating treatment, such that the tetraethoxysilane of step (a) is hydrolyzed to form an ethoxy group-containing silicon hydroxide, and such that the ethoxy group-containing silicon hydroxide and the metal hydroxide compound of step (b) self-assemble to cover the micelle template of step (a), thereby forming a catalyst precursor;
(d) subjecting the catalyst precursor to a washing process until a pH value of a washing liquid generated by the washing process ranges from 7.0 to 7.5, so as to obtain a washed catalyst precursor;
(e) subjecting the washed catalyst precursor to a drying treatment so as to obtain a dried catalyst precursor; and
(f) subjecting the dried catalyst precursor to a calcination treatment conducted at a temperature ranging from 300° C. to 500° C., so as to remove an organic substance containing the micelle template of step (a) from the dried catalyst precursor, thereby obtaining the MCM-41-type catalyst.

2. The method as claimed in claim 1, wherein the cetyltrimethylammonium bromide is present in an amount ranging from 0.9 mole to 1.3 mole, the sodium hydroxide is present in an amount ranging from 0.24 mole to 0.30 mole, and the water is present in an amount ranging from 100 mole to 120 mole based on 1.0 mole of the tetraethoxysilane.

3. The method as claimed in claim 1, wherein the sulfonated tripropylene glycol methyl ether is represented by formula (I),

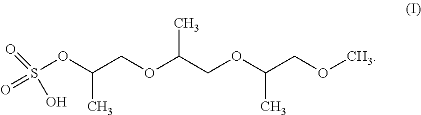 [SMILES: COCC(C)OCC(C)OCC(C)OS(=O)(=O)O]

4. The method as claimed in claim 3, wherein the sulfonated tripropylene glycol methyl ether is obtained by subjecting tripropylene glycol methyl ether and chlorosulfuric acid to a reaction, the tripropylene glycol methyl ether being present in an amount ranging from 1.0 mole to 1.2 mole based on 1.0 mole of the chlorosulfuric acid.

5. The method as claimed in claim 1, wherein the metal compound is selected from the group consisting of an organic titanium compound, an inorganic titanium compound, an organic magnesium compound, an inorganic magnesium compound, an organic aluminum compound, an inorganic aluminum compound, and combinations thereof.

6. The method as claimed in claim 5, wherein the metal compound is the organic titanium compound.

7. The method as claimed in claim 6, wherein the organic titanium compound is titanium isopropoxide.

8. The method as claimed in claim 5, wherein the metal compound is the organic aluminum compound.

9. The method as claimed in claim 8, wherein the organic aluminum compound is aluminum isopropoxide.

10. The method as claimed in claim 1, wherein in step (b), the pH value of the mixture solution is adjusted using a concentrated hydrochloric acid.

11. The method as claimed in claim 1, wherein in step (c), the heating treatment is conducted at a temperature ranging from 80° C. to 100° C.
